(19) United States
(12) Patent Application Publication
(10) Pub. No.: US 2017/0009463 A1
(43) Pub. Date: Jan. 12, 2017

(54) Spreading Device for a Cement Ground

(71) Applicant: Ding-Nan Chen, Taichung City (TW)

(72) Inventor: Ding-Nan Chen, Taichung City (TW)

(21) Appl. No.: 14/795,912

(22) Filed: Jul. 10, 2015

(51) Int. Cl. E04F 21/16; B25G 1/10

(52) U.S. Cl. CPC E04F 21/161; B25G 1/102

(57) ABSTRACT

A spreading device includes a blade, a control structure mounted on the blade, and an operation handle unit connected with the control structure. The control structure includes a base locked onto the blade, a driving stand formed on the base, a limit stand formed on the base, a pivoting support pivotally connected with the limit stand by a screw member, a control rod mounted on the pivoting support, a cam seat secured on a first end of the control rod, a driving rod having a first end pivotally mounted on the driving stand and a second end pivotally connected with and located at an eccentric position of the cam seat, and an elongate push bar having a first end mounted on a second end of the control rod and a second end securely connected with the operation handle unit.

### BACKGROUND OF THE INVENTION

1. Field of the Invention

The present invention relates to a spreading device and, more particularly, to a spreading device for a cement ground.

2. Description of the Related Art

A trowel is used to spread and trim a cement ground that is not dried and cured. The conventional trowel includes a blade with a small width and a short handgrip connected with the blade. However, the blade can only spread a small region of the cement ground at a time so that the conventional trowel needs much working time and energy. A spreading device is used to spread a cement ground with a larger area. A conventional spreading device for a cement ground in accordance with the prior art shown in FIGS. 1-5 comprises a large blade 10, and a control structure 20 mounted on the blade 10. The control structure 20 includes a base 21 locked onto the blade 10, a driving stand 22 formed on the base 21, a limit stand 27 formed on the base 21, a pivoting support 25 having a bottom pivotally connected with the limit stand 27 by a screw member 26, a control rod 30 mounted on the pivoting support 25, a cam seat 24 secured on a first end of the control rod 30, a driving rod 23 having a first end pivotally mounted on a side of the driving stand 22 and a second end pivotally connected with the cam seat 24 and located at an eccentric position of the cam seat 24, and an elongate push bar 31 having a first end mounted on a second end of the control rod 30 and a second end provided with a handgrip 32. The screw member 26 is disposed between the pivoting support 25 and the limit stand 27 to function as a fulcrum. In operation, when the user wishes to push the blade 10 forward, the handgrip 32 is rotated in the clockwise direction as shown in FIG. 4 to rotate the elongate push bar 31 in the clockwise direction, so that the cam seat 24 is rotated with the elongate push bar 31 functioning as a central point. In such a manner, the eccentric position of the cam seat 24 is shifted upward to pull the driving rod 23 upward which pulls the driving stand 22 upward so that the base 21 is turned upward about the screw member 26 which functions as a fulcrum so as to change the angle of the blade 10. Thus, the front end of the blade 10 is lifted and inclined relative to a cement ground “A”, so that the user can push the blade 10 forward. On the contrary, when the user wishes to push the blade 10 backward, the handgrip 32 is rotated in the counterclockwise direction as shown in FIG. 5 to rotate the elongate push bar 31 in the counterclockwise direction, so that the cam seat 24 is rotated with the elongate push bar 31 functioning as a central point. In such a manner, the eccentric position of the cam seat 24 is shifted downward to press the driving rod 23 downward which presses the driving stand 22 downward so that the base 21 is turned downward about the screw member 26 which functions as a fulcrum so as to change the angle of the blade 10. Thus, the rear end of the blade 10 is lifted and inclined relative to the cement ground “A”, so that the user can push the blade 10 backward. However, when the user exerts a force to rotate the handgrip 32, the elongate push bar 31 has a long force arm, and the blade 10 has a determined weight, so that the user cannot operate the handgrip 32, the elongate push bar 31 and the blade 10 easily and conveniently, thereby easily hurting the user's wrist during a long-term utilization. In addition, the user's hand has to hold the handgrip 32 tightly so as to move the blade 10 forward and backward, thereby causing a large load to and easily hurting the user's wrist and arm.

### BRIEF SUMMARY OF THE INVENTION

In accordance with the present invention, there is provided a spreading device comprising a blade, a control structure mounted on the blade, and an operation handle unit connected with the control structure. The control structure includes a base locked onto the blade, a driving stand formed on the base, a limit stand formed on the base, a pivoting support having a bottom pivotally connected with the limit stand by a screw member, a control rod mounted on the pivoting support, a cam seat secured on a first end of the control rod, a driving rod having a first end pivotally mounted on a side of the driving stand and a second end pivotally connected with the cam seat and located at an eccentric position of the cam seat, and an elongate push bar having a first end mounted on a second end of the control rod and a second end securely connected with the operation handle unit.

Preferably, the operation handle unit is directly formed on the second end of the elongate push bar.

Preferably, the handgrip and the control handle allow holding of a user's two hands.

According to the primary advantage of the present invention, the control handle is rotated by the user to have a larger moment, so that the user can operate and rotate the operation handle unit in an energy-saving manner.

According to another advantage of the present invention, the control handle is operated by the user's arm to prevent the user's hand from being hurt.

According to a further advantage of the present invention, the user's two hands hold the handgrip and the control handle of the operation handle unit respectively to move the blade forward and backward, so that the user can operate and change the angle of the blade easily and conveniently in an energy-saving manner.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional spreading device in accordance with the prior art.

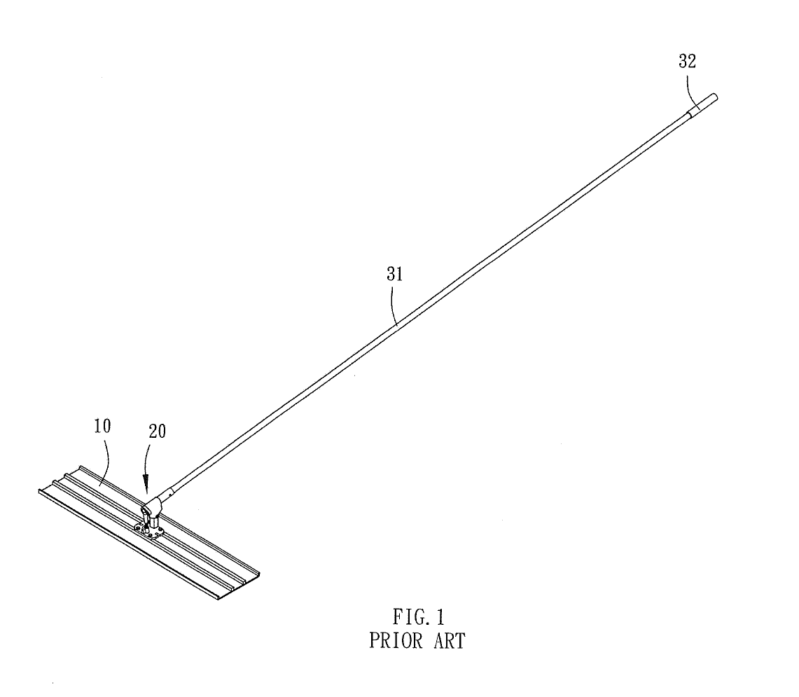

FIG. 2 is a partially exploded perspective view of the conventional spreading device as shown in FIG. 1.

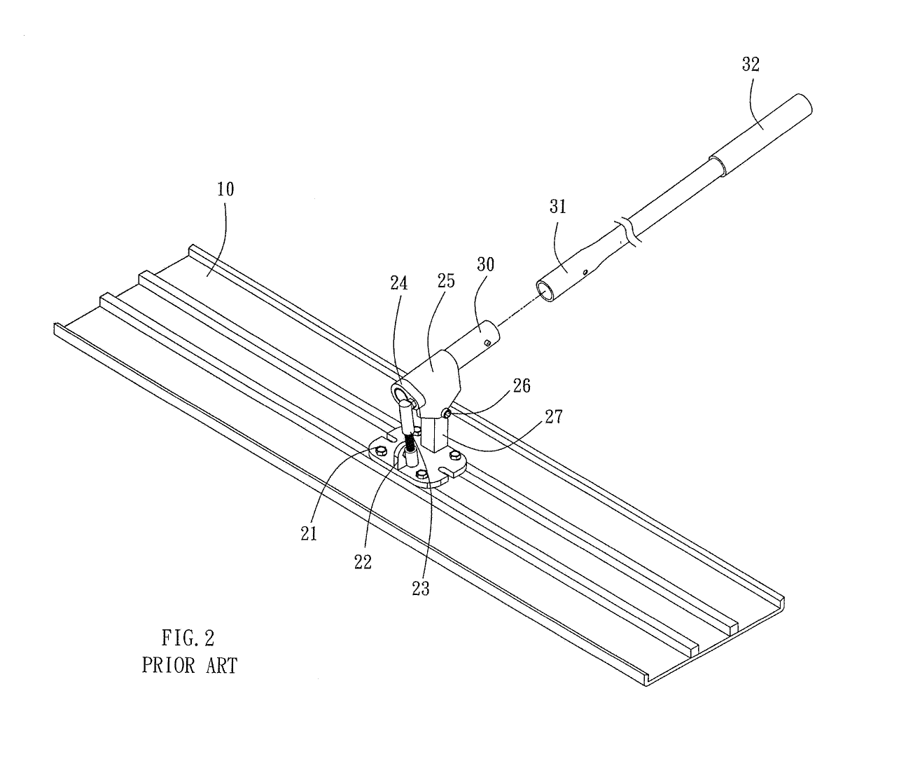

FIG. 3 is a cross-sectional view of the conventional spreading device as shown in FIG. 1.

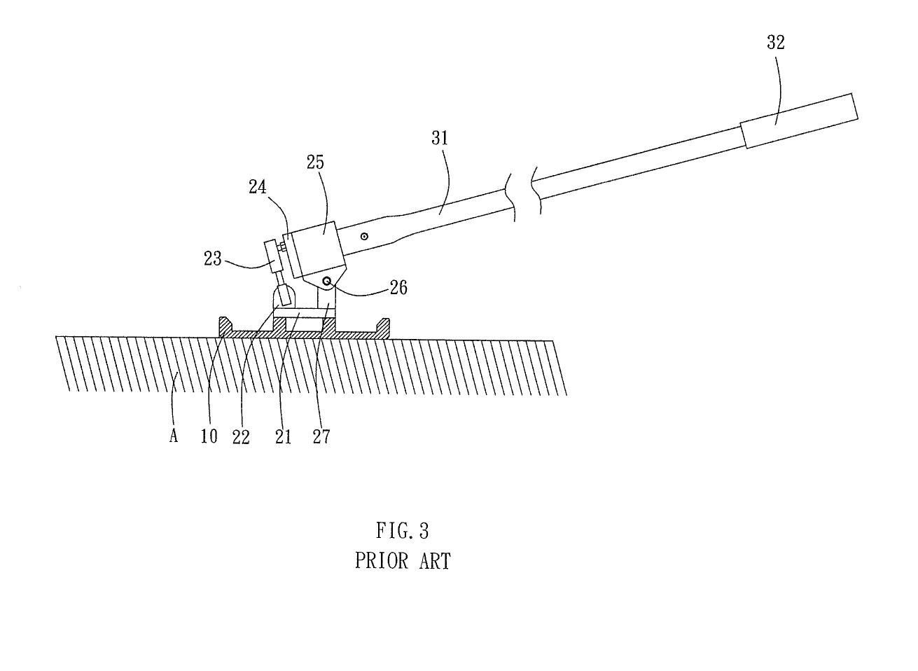

FIG. 4 is an operational view of the conventional spreading device as shown in FIG. 3.

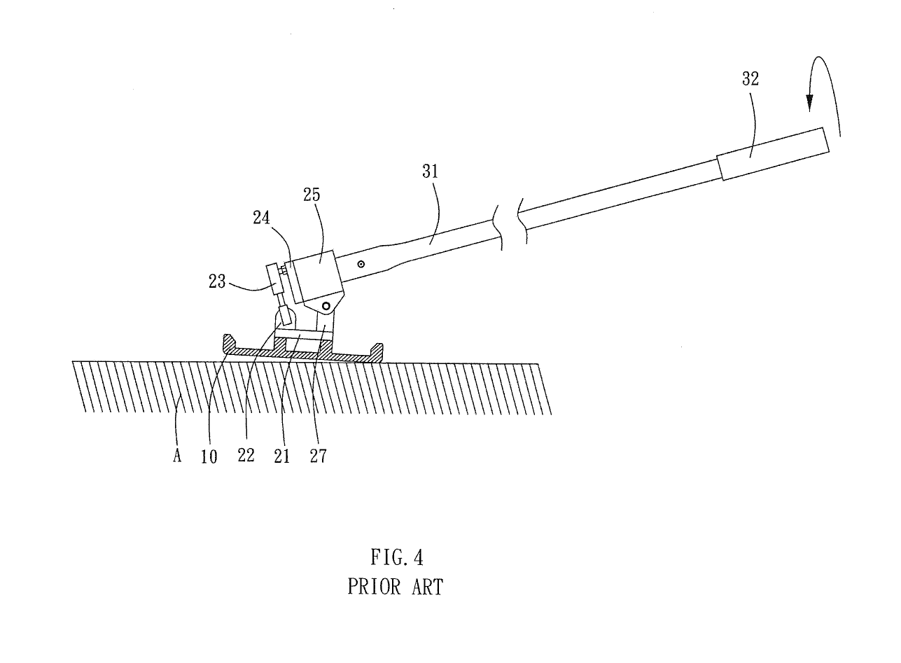

FIG. 5 is an operational view of the conventional spreading device as shown in FIG. 3.

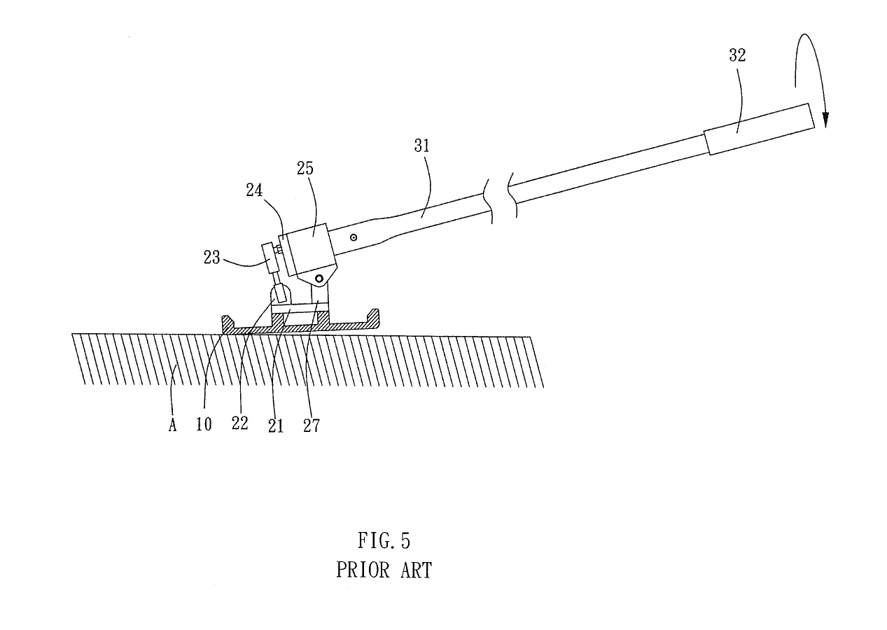

FIG. 6 is a perspective view of a spreading device in accordance with the preferred embodiment of the present invention.

FIG. 7 is a partially exploded perspective view of the spreading device as shown in FIG. 6.

FIG. 8 is a perspective view of a spreading device in accordance with another preferred embodiment of the present invention.

FIG. 9 is a perspective view of a spreading device in accordance with a further preferred embodiment of the present invention.

### DETAILED DESCRIPTION OF THE INVENTION

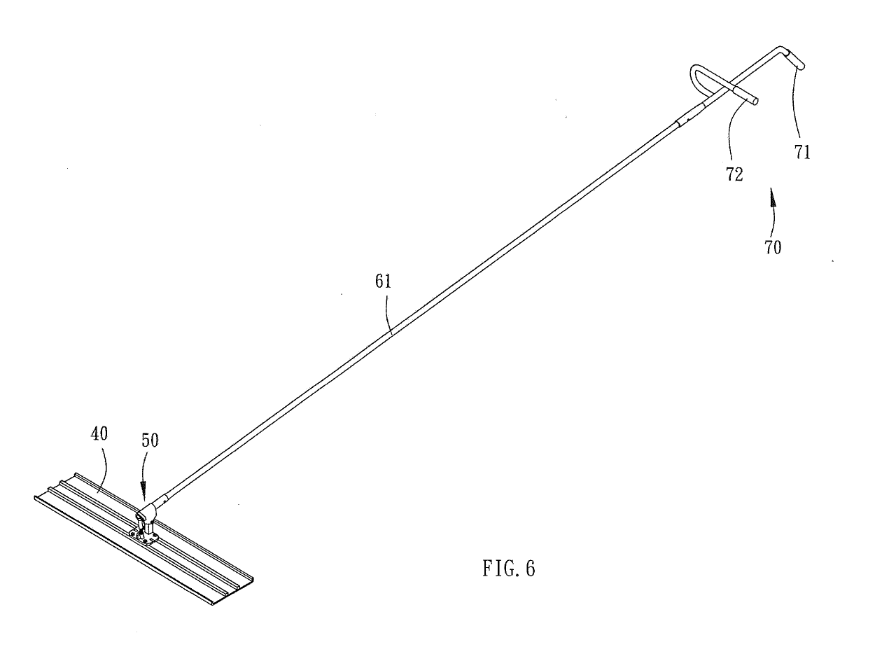

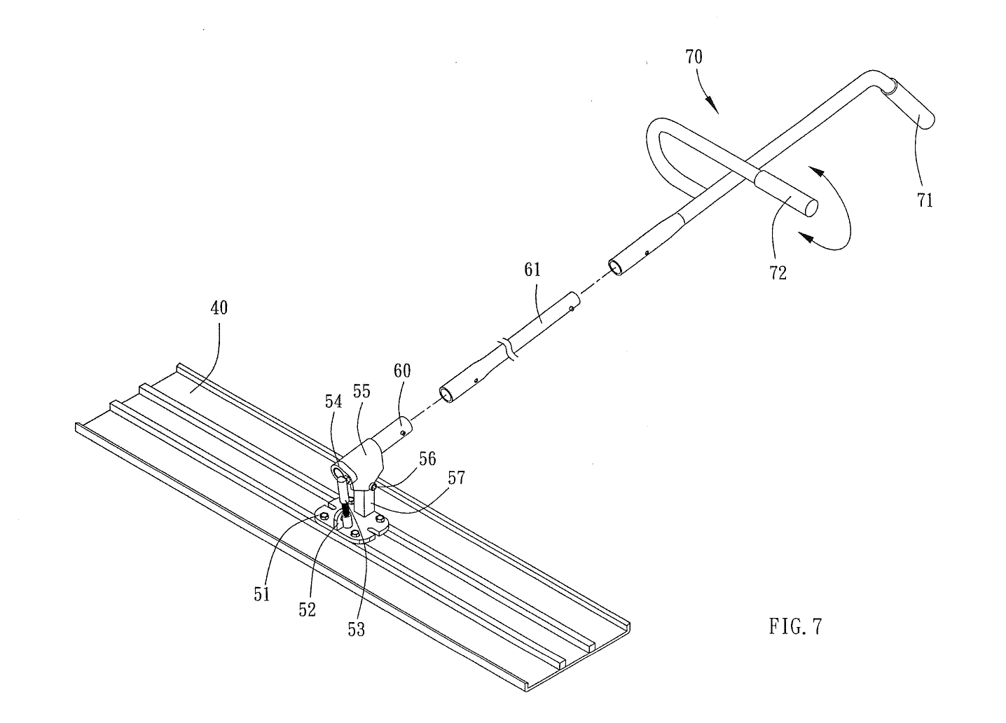

Referring to the drawings and initially to FIGS. 6 and 7, a spreading device in accordance with the preferred embodiment of the present invention comprises a large blade 40, a control structure 50 mounted on the blade 40, and an operation handle unit 70 connected with the control structure 50.

The control structure 50 includes a base 51 locked onto the blade 40, a driving stand 52 formed on the base 51, a limit stand 57 formed on the base 51, a pivoting support 55 having a bottom pivotally connected with the limit stand 57 by a screw member 56, a control rod 60 mounted on the pivoting support 55, a cam seat 54 secured on a first end of the control rod 60, a driving rod 53 having a first end pivotally mounted on a side of the driving stand 52 and a second end pivotally connected with the cam seat 54 and located at an eccentric position of the cam seat 54, and an elongate push bar 61 having a first end mounted on a second end of the control rod 60 and a second end securely connected with the operation handle unit 70. The screw member 56 is disposed between the pivoting support 55 and the limit stand 57 to function as a fulcrum.

The operation handle unit 70 includes a handgrip 71 and a control handle 72. When in use, the handgrip 71 and the control handle 72 allow holding of a user's two hands. In the preferred embodiment of the present invention, the handgrip 71 is connected with the elongate push bar 61, and the control handle 72 is connected with the handgrip 71. Preferably, the operation handle unit 70 is detachably connected with the elongate push bar 61. Alternatively, the operation handle unit 70 is directly formed on the second end of the elongate push bar 61.

In operation, the user's two hands hold the handgrip 71 and the control handle 72 of the operation handle unit 70 respectively so as to operate the blade 40. When the user wishes to change the angle of the blade 40, the handgrip 71 functions as a fulcrum, and the control handle 72 functions as a force application point, to rotate in the clockwise or counterclockwise direction, so as to drive the elongate push bar 61 which drives the control structure 50, so that the cam seat 54 is rotated with the elongate push bar 61 functioning as a central point. In such a manner, the eccentric position of the cam seat 54 is shifted upward or downward so that the driving rod 53, the driving stand 52 and the base 51 are operated and rotated about the screw member 56 which functions as a fulcrum (the driving manner of the control structure 50 is similar to that of the conventional control structure and will not be further described in detail) so as to change the angle of the blade 40.

Accordingly, the control handle 72 is rotated by the user to have a larger moment, so that the user can operate and rotate the operation handle unit 70 in an energy-saving manner. In addition, the control handle 72 is operated by the user's arm to prevent the user's hand from being hurt. Further, the user's two hands hold the handgrip 71 and the control handle 72 of the operation handle unit 70 respectively to move the blade 40 forward and backward, so that the user can operate and change the angle of the blade 40 easily and conveniently in an energy-saving manner.

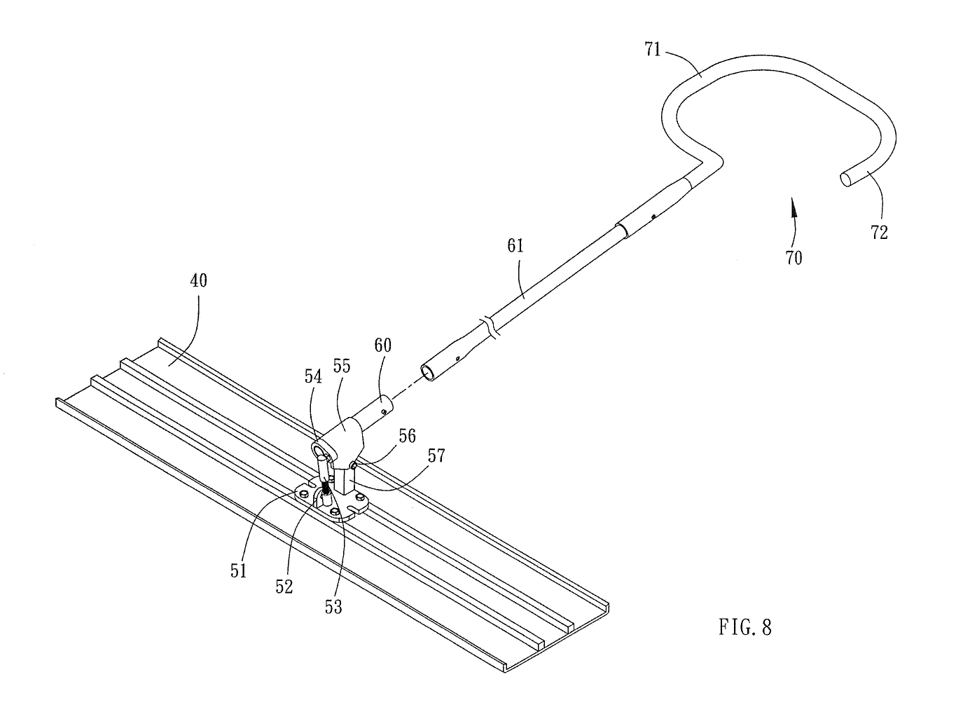

Referring to FIG. 8, the handgrip 71 has a first end connected with the elongate push bar 61 and a second end connected with the control handle 72.

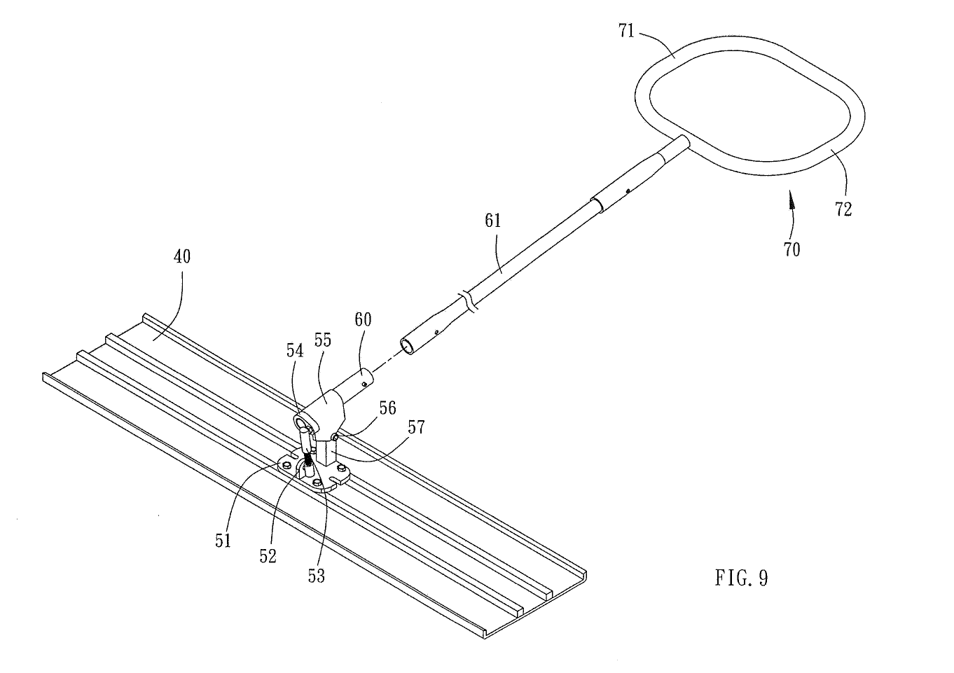

Referring to FIG. 9, the handgrip 71 and the control handle 72 are integrated to have an endless shape.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A spreading device comprising:
a blade;
a control structure mounted on the blade; and
an operation handle unit connected with the control structure;
wherein:
the control structure includes:
a base locked onto the blade;
a driving stand formed on the base;
a limit stand formed on the base;
a pivoting support having a bottom pivotally connected with the limit stand by a screw member;
a control rod mounted on the pivoting support;
a cam seat secured on a first end of the control rod;
a driving rod having a first end pivotally mounted on a side of the driving stand and a second end pivotally connected with the cam seat and located at an eccentric position of the cam seat; and
an elongate push bar having a first end mounted on a second end of the control rod and a second end securely connected with the operation handle unit; and
the operation handle unit includes a handgrip and a control handle.

2. The spreading device of claim 1, wherein the operation handle unit is directly formed on the second end of the elongate push bar.

3. The spreading device of claim 1, wherein the handgrip and the control handle allow holding of a user's two hands.
